(19) United States
(12) Patent Application Publication
(10) Pub. No.: US 2002/0135504 A1
(43) Pub. Date: Sep. 26, 2002

(54) Networked radar detection system and method

(76) Inventor: Neil Singer, Armonk, NY (US)

Correspondence Address: Greenberg Traurig, LLP, 21st Floor, 885 Third Avenue, New York, NY, 10022, US

(21) Appl. No.: 10/118,702

(22) Filed: Apr. 9, 2002

Related U.S. Application Data
(60) Provisional application No. 60/282,530, filed on Apr. 9, 2001.

(51) Int. Cl. G01S 7/40

(52) U.S. Cl. 342/20; 342/56; 342/58; 342/104; 342/107; 342/114; 342/115; 342/357.08; 342/357.09; 342/357.1

(57) ABSTRACT

A police radar and laser detector with networking capability is disclosed. By including the ability to wirelessly transmit the existence or even location of a detected radar or laser source, overall performance can be improved. Transmission of an actual radar or laser location gives other detectors advanced warning. Additionally, transmission of false alarm locations will allow other detectors to reduce false alarms.

### CROSS REFERENCE TO RELATED UNITED STATES APPLICATION

This application claims priority from United States Provisional Patent Application No. 60/282,530, filed on Apr. 9, 2001, by Singer, the contents of which are herein incorporated by reference.

### BACKGROUND OF THE INVENTION

Police radar and laser detectors work by detecting a police speed measurement signal and sounding an audio or visual alarm or warning to the operator. The fundamental tradeoff in designing a radar or laser detector is increasing sensitivity without increasing false alarms. In addition, many police radar and laser units use an instant activation feature in which they turn on briefly to capture an individual automobile's speed and turn off again. This feature, when used on police radar and laser units, makes detection difficult.

Radar and laser detectors, therefore, must detect a radar or laser unit as quickly as possible. As a result, false alarms are commonplace. Some advanced units, such as the Valentine One, manufactured by Valentine Research, Inc., even display the location and number of distinct sources of radar or laser signals. This further aids in sorting out signals detected by the device.

U.S. Pat. Nos. 5,151,701, 5,083,129 and 5,111,210 disclose a detector that determines and displays the relative direction of a radar source.

U.S. Pat. Nos. 5,300,932, 5,146,226, 5,250,951 and 5,206,651 disclose a detector capable of detecting and displaying the number of radar sources detected.

U.S. Pat. No. 5,977,884 discloses a radar detector with a GPS built in to determine the vehicle speed. However, the location of the detector as provided by the GPS is not used.

Several patents disclose additional features to radar and laser detectors. For example, U.S. Pat. No. 5,717,398 discloses a solar power option with automatic sensing to determine when to turn off.

U.S. Pat. No. 5,510,793 discloses a feature whereby the vehicle speed is measured and printed out in response to a radar or laser-triggering signal. This provides a speed confirmation useful in fighting a ticket.

U.S. Pat. No. 4,887,086 combines a CB scanner with a radar detector.

What is lacking in this art is the ability to increase radar and laser sensitivity and/or reduce false alarms by using information from other vehicle's radar and laser detectors or other data sources external to the detector.

### SUMMARY OF THE INVENTION

Disclosed herein is a new wireless technology that enables radar and laser detectors from different vehicles to communicate to further enhance the performance of the individual radar detector units. Also disclosed is the use of information external to the detector to aid in presenting information to the detector user. The information presented to the user is usually an audio or visual warning, however, any warning means may be utilized. The goal of these improvements is to incorporate additional information not normally available to current detectors to improve detector sensitivity by either expanding the range of detection to enable earlier detection, or by reducing false alarms. In one embodiment, the units communicate locally with each other on a peer-to-peer basis. In a second embodiment, the units wirelessly communicate with each other via a central server. Any type or combination of wireless electromagnetic communication can be utilized, such as radio or microwave frequency communication, infrared, or cellular telephone communication. The central server need not be land based, and could be a satellite connection. The detectors could also detect other types of electromagnetic signals besides radar and laser signals.

### BRIEF DESCRIPTIONS OF THE DRAWING

FIG. 1 depicts a central or regional wireless connection embodiment of the invention.

FIG. 2 depicts a local wireless connection embodiment of the invention.

FIG. 3 depicts a combined local and central wireless connection embodiment of the invention.

FIG. 4 depicts a schematic block diagram of the detector of the invention.

### DETAILED DESCRIPTION OF THE PREFERRED EMBODIMENTS

There are two basic embodiments for this invention. In the first embodiment, the radar/laser detector (“detector”) units talk peer-to-peer. The detector units send signals that are interpreted by nearby detectors and the nearby detectors process the information and display a signal or warning to the operator.

In the second embodiment, one or many central servers communicate with multiple detector unit clients. In this case, the detectors transmit information to a central computer, which processes the information and sends results to other detectors in the area.

Peer-to-Peer Communication

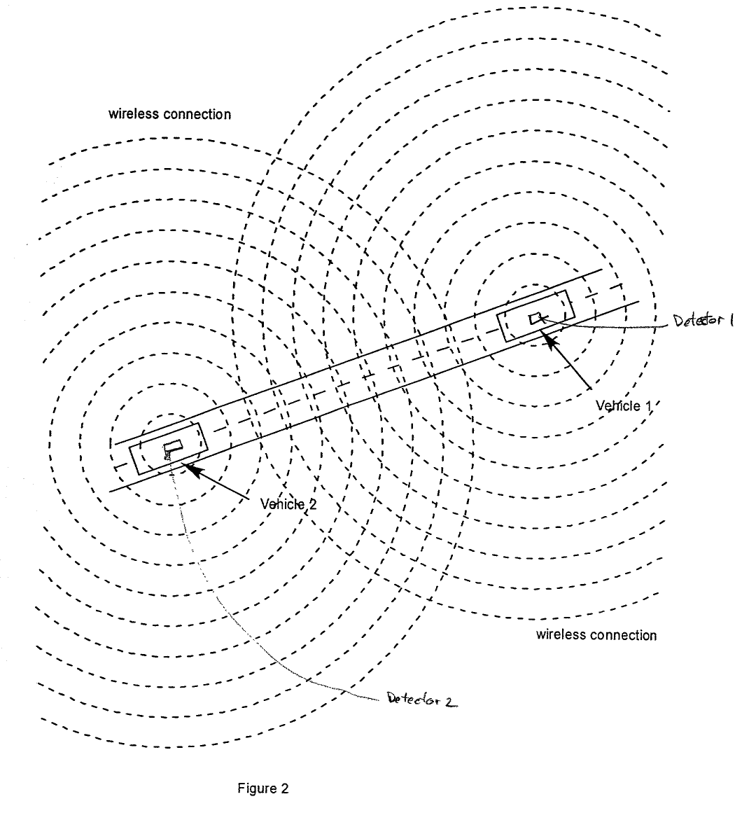

In the first embodiment, illustrated in FIG. 2, each detector unit transmits a local signal. This signal uses any wireless electromagnetic technology. Some examples include radio frequency (such as cordless phones), infrared (such as remote controls), microwave (potentially even using the same frequencies as the police radar source or “rebroadcasting” the radar signal), or even cellular or CDPD communications. FIG. 2 schematically illustrates vehicle (1) and vehicle (2) and their respective signals.

The basic operation involves a first detector (1) in vehicle (1) receiving a police radar or laser signal. The first detector (1) sends a signal. Other detectors within range of the first detector, such as detector (2) in vehicle (2), receive the signal and interpret the information. For example, the signal can encode any number of items including but not limited to: the location of the radar or laser source, the type of source, the direction of travel, the range to the source, the number of sources. Additionally, the information may be used for any of a multitude of purposes, including alerting the driver to a potential radar source, suppressing the warning from a known or likely false source (e.g. a noise source that is not a police radar or laser), or a traffic warning, etc.

It will be apparent to those skilled in the art that the information sent, received, or measured by a radar detector may be used immediately or stored for possible future use. This includes location information determined from the GPS or its equivalent.

Additionally, the peer-to-peer arrangement is also capable of relaying information acquired from other detector units. This enables a detector to communicate with other detectors located in the same general vicinity. For example, Detector A may send information to Detector C by way of Detector B.

Client-Server Communication

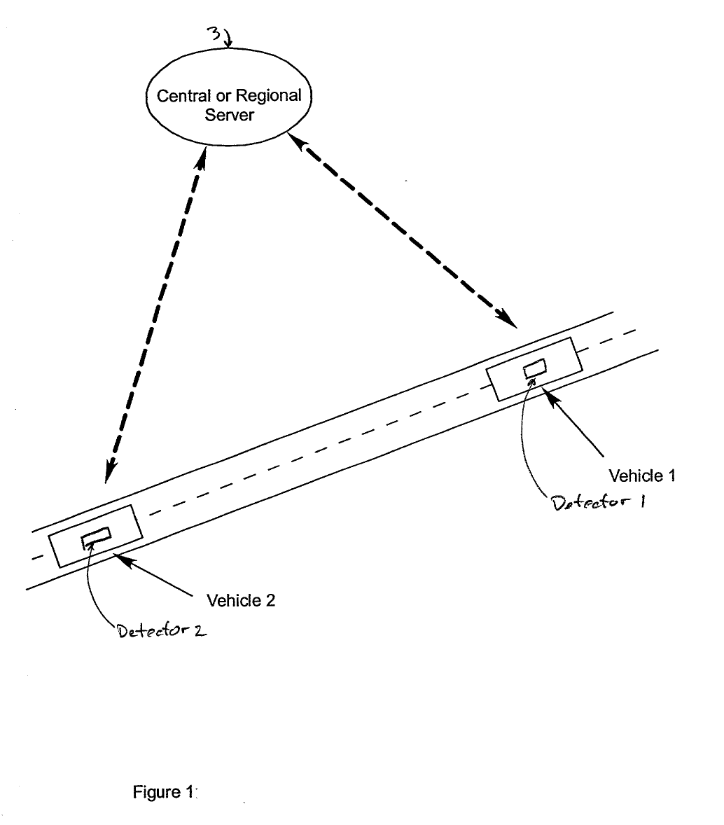

In the client-server embodiment, illustrated in FIG. 1, each detector unit transmits a signal to a remotely located or central server (3). As with the first embodiment, this signal can use any wireless electromagnetic technology. FIG. 1 schematically illustrates the central server (3) and vehicles (1) and (2) and their respective signals.

The basic operation involves a first detector (1) in vehicle (1) receiving a police radar or laser signal or any other electromagnetic signal. The first detector (1) sends a signal to the central server (3). The central server (3) in turn transmits a signal to other detectors within range of the first detector, such as detector (2) in vehicle (2), which receive the signal and interpret the information. For example, the signal can encode any number of items including but not limited to: the location of the radar or laser source, the type of source, the direction of travel, the range to the source, the number of sources. As with the first embodiment, the information may be used for any of a multitude of purposes, including alerting the driver to a potential radar source, suppressing the warning from a known or likely false source (e.g. a noise source that is not a police radar or laser), or a traffic warning, etc.

Note that any wireless technology can be used to facilitate the communication between detector units and that the technology is not limited to any one particular communication method. In addition, the central server need not be land based, and could be located on a satellite.

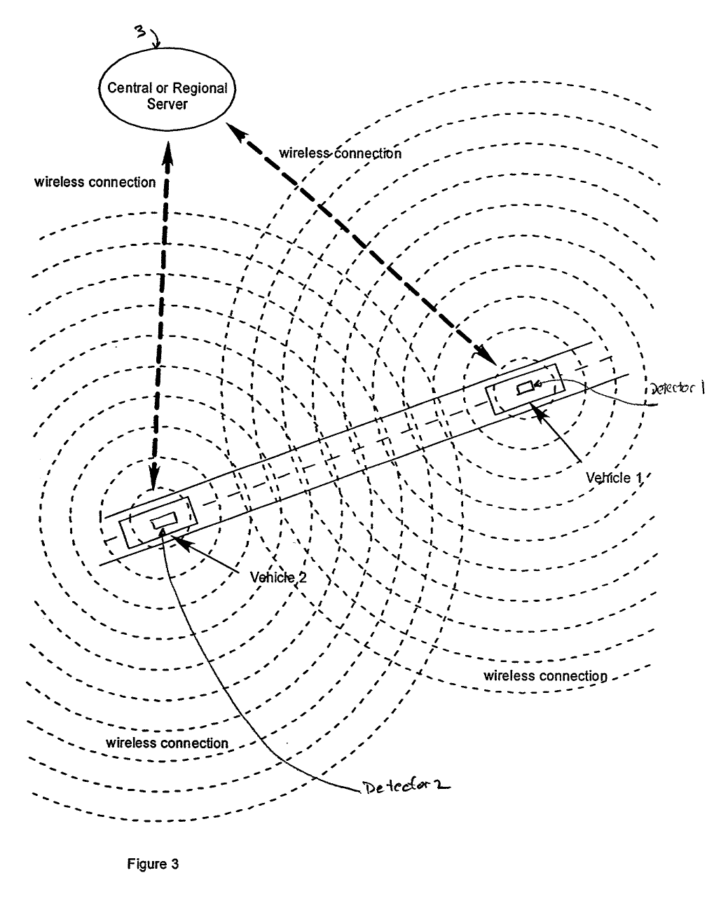

It is important to note that both embodiments can be deployed. This is illustrated in FIG. 3. For example, a local signal from detector (1) in vehicle (1) could be broadcast peer-to-peer to immediately warn nearby detectors, such as vehicle (2), while a signal to the central server (3) is transmitted. This configuration enables the system to work even in geographic areas in which the centralized network is unavailable. Information can then be routed to the centralized server (3) once network communications is reestablished. Additionally, the network can anticipate such “blackouts” and download information to a client detector in anticipation of a user's future location.

Global Positioning System (GPS)

As an alternative to either approach, incorporating a GPS receiver into the detector design would further enhance functionality. This enables transmittal of accurate location and travel direction information to other detectors. This is more important in the client-server configuration because the natural range of the peer-to-peer configuration would limit applicable range. Note that as alternatives to GPS are developed for establishing position, velocity, and/or direction of travel information, those skilled in the art will recognize that any such alternative can be readily used in place of GPS for the same purpose.

Once positional information is available, much of the functionality of using transmitted or received information can be obtained using a local database. For example, if a database of known false alarm locations or known speed detection locations is available within the detector (either by loading it or by transmitting to it), the detector can make the same decisions about alerting the user described elsewhere in this document. It is recognized that one need not obtain this information over the airwaves. In one embodiment, one can load the detector from a CD, from over the internet, from a laptop, at manufacture or through any other method as a means of implementing the communications circuit (15).

Once a GPS or similar position location device is added to the detector, detected signals or other information can be processed as a function of location. For example, if the signal strength of a radar signal is monitored as a function of detector position, a more accurate model of the sources location(s) can be determined while traveling by recording the strength at several different locations.

Combination with a Navigation System

The networkable radar detector can also be an accessory to a navigation system. In this case, the location, direction of travel, speed and likely future route of travel are all available. This information can be used in combination with information from other radar detectors and other information sources (such as information from a central server) to plan a route, display proper warnings, and “weed-out” false alarms.

Detailed Implementation

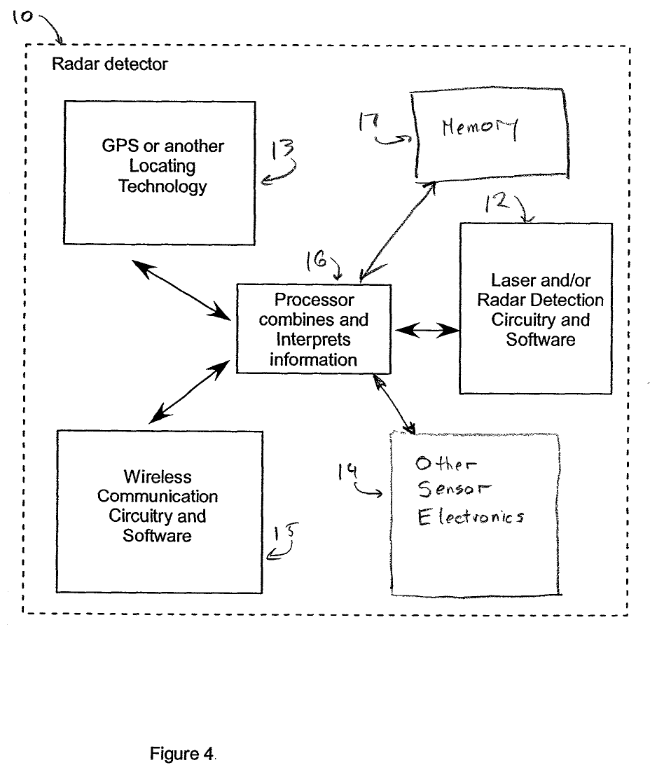

Referring now to FIG. 4, a radar detector (10) includes electrical circuitry (12) for detecting various radar, laser, and traffic signals, as is generally available in the current state of the art. Location detection circuitry (13) can be included so that location information can be either stored or transmitted. Other sensor electronics (14) can be added to provide other functionality, such as, for example, temperature, pressure, weather, and traffic information. Communications circuitry (15) can be included so that the detector can receive information from other detectors at some other locations. This communications circuitry (15) can also function as transmission electronics so that the detector can transmit information such as, for example, radar, laser, traffic, and location information. The transmitted information can be sent to other detectors, a central site, or any other location. Finally, the detector (10) includes a processor (16) that is communicatively connected with the aforementioned components to receive, combine, interpret, and transmit information.

Note that although the figure shows the communications circuitry (15) as one element, it is anticipated that the communications circuitry or any other circuitry can consist of several separate circuits. For example, several different communication protocols can be simultaneously supported and the unit can choose which protocol to use or use several at once (i.e. CDPD and radio).

One purpose of transmitting such information is to give advanced warning to other compatible detectors, or to reduce false readings in other detectors. Other information can be included in these transmissions, such as but not limited to, traffic and/or road conditions, temperature, or weather information. The detector can also be used to transmit information that originates with the detector's user or with other electronic devices, including but not limited to, voice, data, and video.

The information collected by the detector may or may not necessarily be transmitted by the communications electronics (15). The information can merely be stored internally in the detector's memory (17) and used by the detector. The memory (17) can be any kind of conventional memory, for example, without limitation, RAM, non-volatile RAM, or memories such as EEPROM, flash memory, memory “sticks,” floppy disks, CR-RW, DVD-RW or even a hard disk drive. A preloaded database of information can also be used or loaded into the unit in the form of a CD, DVD, miniCD or the like.

Without departing from the scope of the invention, a detector can be constructed with only a receiving capability and no transmission capability. This could be the basis of a low cost model, or a model used only to receive external sensor information from detectors with transmission capability or from, e.g., fixed installation transmitters.

One detector may or may not know that another detector is within range. For example, it may “blindly” send out a signal to other detectors if any are in range. Alternatively, one detector could request information from detectors in an area. Those skilled in the art will recognize that there are many ways to establish similar communication protocols once detectors with transmit and/or receive capabilities exist.

One example of how the system could be programmed to work is as follows:

1. Detector A detects a Ka band radar signal.

2. Detector A determines its location using the GPS system.

3. Detector A stores the location for future reference and sends the location, radar type and signal strength to detector B (although detector A does not necessarily know that detector B is within range).

4. Detector B uses its GPS to determine its position upon receiving detector A's information, and uses this information with the information received from detector A to estimate the location of the radar signal source.

5. Detector B determines that it is approaching the location of the radar source indicated by detector A.

6. Detector B signals its user to provide advance warning of the possible police radar source.

7. Detector B may or may not use its own detecting circuitry to verify the existence of the radar source (for example, by triggering at a lower signal level than it might otherwise).

A second example of how the system could be programmed to work is as follows:

8. Detector A detects an X band radar signal, which it determines (either by past experience or by operator input or by signal processing over time) is a false alarm.

9. Detector A determines its location using the GPS system.

10. Detector A stores the location for future reference and sends the location, radar type, signal strength, and false alarm status to detector B (although detector A does not necessarily know that detector B is within range).

11. Detector B uses it GPS to determine its position upon receiving detector A's information.

12. Detector B determines that it is approaching the location of the radar source indicated by detector A

13. Detector B suppresses its signal to its user (or alternatively changes its sensitivity level in case an error may have occurred in determining the false alarm).

Other Applications

It is appreciated that the transmit and receive capabilities described above can have many applications. For example, once information receiving capability has been added to a detector, that capability can be used to receive sensor information from other parts of the vehicle. For example, a temperature sensor, weather electronics, or even a radar or laser jamming device can be mounted elsewhere in the vehicle and information from those devices can be transmitted back to the detector.

In addition, if the detector collects information, this information can be sent locally within the vehicle as well. For example, receiving a radar signal (or information from another detector) can be used to send information to a radar or laser-jamming unit so that it can operate. This feature can enable additional functionality without having to run as many wires throughout the vehicle.

While the present invention has been described and illustrated in various preferred and alternate embodiments, such descriptions and illustrations are not to be construed to be limitations thereof. Accordingly, the present invention encompasses any variations, modifications and/or alternate embodiments with the scope of the present invention being limited only by the claims which follow.

What is claimed is:

1. An apparatus for detecting electromagnetic signals, said apparatus comprising:
means for detecting electromagnetic signals;
means for determining the position location of said detection means; and
means for processing the detected electromagnetic signals,
wherein information received from the position location determination means can be combined with signals detected by the detecting means to improve detection sensitivity and/or reduce false detection alarms.

2. The apparatus of claim 1, further comprising memory means for storing signals received by the detecting means or from the communications means.

3. The apparatus of claim 1, wherein the position location determination means is a GPS sensor.

4. The apparatus of claim 1, wherein the detected electromagnetic signals include radar signals and/or laser signals.

5. The apparatus of claim 1, further comprising means for wireless electromagnetic communications.

6. The apparatus of claim 5, wherein the communications means can transmit signals to either another detection apparatus, a remotely located server, or to both another detection apparatus and a remotely located server.

7. The apparatus of claim 6, wherein information transmitted by the communications means comprises at least one of the location of the electromagnetic signal source, the detector location, the type of signal source, the number of signal sources, the direction of motion of the signal source, the direction of motion of the detector, and the range of the source.

8. The apparatus of claim 5, wherein the communications means can receive signals from either another detection apparatus, a remotely located server, or from both another detection apparatus and a remotely located server, and wherein the processing means can analyze these received signals with the detected signals to improve detection sensitivity and/or reduce false detection alarms.

9. The apparatus of claim 8, wherein information received from the communications means comprises at least one of the location of the electromagnetic signal source, the type of signal source, the number of signal sources, the direction of motion of the signal source, the direction of motion of the detector and the range of the source.

10. The apparatus of claim 5, wherein the communications means communicates signals via at least one of radio frequency signals, microwave signals, infrared signals, or cellular telephone signals.

11. The apparatus of claim 6, wherein the communications means can relay a signal received by the communications means to another detection apparatus.

12. The apparatus of claim 1, further comprising sensor means for sensing other information.

13. The apparatus of claim 12, wherein the other information can include at least one of temperature, pressure, weather information and traffic information.

14. The apparatus of claim 1, wherein the communications means can transmit information to and receive information from other electrical devices within a vehicle.

15. An apparatus for detecting electromagnetic signals, said apparatus comprising:
means for detecting electromagnetic signals;
means for wireless electromagnetic communications, wherein said communications means can transmit electromagnetic communications signals; and
means for processing the detected electromagnetic signals,
wherein signals detected by the detecting means can be transmitted to either another detection apparatus, a remotely located server, or to both another detection apparatus and a remotely located server, to improve detection sensitivity and/or reduce false detection alarms.

16. The apparatus of claim 15, further comprising memory means for storing signals received by the detecting means or from the communications means.

17. The apparatus of claim 15, wherein the detected electromagnetic signals include radar signals and/or laser signals.

18. The apparatus of claim 15, further comprising means for determining a position location of said detection apparatus.

19. The apparatus of claim 18, wherein the position location determination means is a GPS sensor.

20. The apparatus of claim 15, wherein information transmitted by the communications means comprises at least one of the location of the electromagnetic signal source, the type of signal source, the number of signal sources, the direction of motion of the signal source, the direction of motion of the detector, and the range of the source.

21. The apparatus of claim 15, wherein the communications means can receive signals from either another detection apparatus, a remotely located server, or from both another detection apparatus and a remotely located server, and wherein the processing means can analyze these received communications signals with the detected signals to improve detection sensitivity and/or reduce false detection alarms.

22. The apparatus of claim 21, wherein information received from the communications means comprises at least one of the location of the electromagnetic signal source, the type of signal source, the number of signal sources, the direction of motion of the signal source, the direction of motion of the detector, and the range of the source.

23. The apparatus of claim 15, wherein the communications means communicates signals via at least one of radio frequency signals, microwave signals, infrared signals, or cellular telephone signals.

24. The apparatus of claim 21, wherein the communications means can relay a signal received by the communications means to another detection apparatus.

25. The apparatus of claim 15, further comprising sensor means for sensing other information.

26. The apparatus of claim 25, wherein the other information can include at least one of temperature, pressure, weather information and traffic information.

27. The apparatus of claim 15, wherein the communications means can transmit information to and receive information from other electrical devices within a vehicle.

28. An apparatus for detecting electromagnetic signals, said apparatus comprising:
means for detecting electromagnetic signals;
means for wireless electromagnetic communications, wherein said communications means can receive electromagnetic communications signals; and
means for processing the detected electromagnetic signals,
wherein the processing means can analyze the detected signals with the received communications signals to improve detection sensitivity and/or reduce false detection alarms.

29. The apparatus of claim 28, further comprising memory means for storing signals received by the detecting means or from the communications means.

30. The apparatus of claim 28, wherein the detected electromagnetic signals include radar signals and/or laser signals.

31. The apparatus of claim 28, further comprising means for determining a position location of said detection apparatus.

32. The apparatus of claim 31, wherein the position location determination means is a GPS sensor.

33. The apparatus of claim 28, wherein the electromagnetic communications signals can be received from either another detection apparatus, a remotely located server, or from both another detection apparatus and a remotely located server.

34. The apparatus of claim 28, wherein information received by the communications means comprises at least one of the location of the electromagnetic signal source, the type of signal source, the number of signal sources, the direction of motion of the signal source, the direction of motion of the detector, and the range of the source.

35. The apparatus of claim 28, wherein the communications means can transmit signals to either another detection apparatus, a remotely located server, or to both another detection apparatus and a remotely located server.

36. The apparatus of claim 35, wherein information transmitted by the communications means comprises at least one of the location of the electromagnetic signal source, the type of signal source, the number of signal sources, the direction of motion of the signal source, the direction of motion of the detector, and the range of the source.

37. The apparatus of claim 28, wherein the communications means communicates signals via at least one of radio frequency signals, microwave signals, infrared signals, or cellular telephone signals.

38. The apparatus of claim 35, wherein the communications means can relay a signal received by the communications means to another detection apparatus.

39. The apparatus of claim 28, further comprising sensor means for sensing other information.

40. The apparatus of claim 39, wherein the other information can include at least one of temperature, pressure, weather information and traffic information.

41. The apparatus of claim 28, wherein the communications means can transmit information to and information receive from other electrical devices within a vehicle.

42. An apparatus for detecting electromagnetic signals, said apparatus comprising:
means for detecting electromagnetic signals;
means for determining a position location of said detection apparatus or signal source;
means for wireless electromagnetic communications, wherein said communications means can transmit or receive electromagnetic communications signals; and
means for processing the detected electromagnetic signals,
wherein the processing means can analyze the detected signals with the received communications signals to improve detection sensitivity and/or reduce false detection alarms.

43. The apparatus of claim 42, further comprising memory means for storing signals received by the detecting means or from the communications means.

44. The apparatus of claim 42, wherein the detected electromagnetic signals include radar signals and/or laser signals.

45. The apparatus of claim 42, wherein the position location determination means is a GPS sensor.

46. The apparatus of claim 42, wherein the electromagnetic communications signals can be transmitted to or received from either another detection apparatus, a remotely located server, or from both another detection apparatus and a remotely located server.

47. The apparatus of claim 42, wherein information transmitted or received by the communications means comprises at least one of the location of the electromagnetic signal source, the type of signal source, the number of signal sources, the direction of motion of the signal source, the direction of motion of the detector, and the range of the source.

48. The apparatus of claim 42, wherein the communications means communicates signals via at least one of radio frequency signals, microwave signals, infrared signals, or cellular telephone signals.

49. The apparatus of claim 42, wherein the communications means can relay a signal received by the communications means to another detection apparatus.

50. The apparatus of claim 42, further comprising sensor means for sensing other information.

51. The apparatus of claim 50, wherein the other information can include at least one of temperature, pressure, weather information and traffic information.

52. The apparatus of claim 42, wherein the communications means can transmit information to and receive information from other electrical devices within a vehicle.

53. A method for detecting an electromagnetic signal comprising the steps of:
receiving by a detector information regarding an electromagnetic signal;
analyzing said information to determine whether said electromagnetic signal constitutes a false detection alarm;
determining the location of said detector; and
upon approaching said location of said source, issuing a warning if the electromagnetic signal was determined not to be a false signal.

54. The method of claim 53, further comprising the step of detecting by the detector the electromagnetic signal about which information was received.

55. The method of claim 53, further comprising the step of estimating the location of a source of said electromagnetic signal.

56. The method of claim 53, wherein the electromagnetic signal about which information was received can be a radar signal and/or a laser signal.

57. The method of claim 53, wherein the information regarding an electromagnetic signal can be received from either another detection apparatus, a remotely located server, or from both another detection apparatus and a remotely located server.

58. The method of claim 53, wherein the information regarding an electromagnetic signal comprises at least one of the location of the electromagnetic signal source, the type of signal source, the number of signal sources, the direction of motion of the signal source, the direction of motion of the detector, and the range of the source.

59. The method of claim 53, wherein the location of said detector is determined by a GPS sensor.

60. The method of claim 53, further comprising the step of relaying the information regarding an electromagnetic signal to another detector.

61. The method of claim 61, further comprising the step of storing said information regarding an electromagnetic signal.

62. The method of claim 61, further comprising the step of sensing other information.

63. The method of claim 62, wherein the other information can include at least one of temperature, pressure, weather information and traffic information.

64. A method for processing an electromagnetic signal comprising the steps of:
detecting an electromagnetic signal with a first detector;
determining the location of said detector;
storing the location of said detector; and
transmitting information regarding the detected electromagnetic signal and the location of the detector.

65. The method of claim 64, wherein the location of said detector is determined by a GPS sensor.

66. The method of claim 64, further comprising the steps of determining a location of a source of said electromagnetic signal; and
storing said electromagnetic signal source location.

67. The method of claim 64, wherein the information can be transmitted to at least one of a second detector or a remote server.

68. The method of claim 64, wherein the transmitted information comprises at least one of the location of the electromagnetic signal source, the type of signal source, the number of signal sources, the direction of motion of the signal source, the direction of motion of the detector, and the range of the source.

69. The method of claim 64, further comprising the step of sensing other information.

70. The method of claim 69, wherein the other information can include at least one of temperature, pressure, weather information and traffic information.

71. The method of claim 64, further comprising the step of receiving from another detector information regarding the detected electromagnetic signal.

72. A speed-detection alert system, comprising:
a detector having:
a first sensor capable of detecting a signal transmitted for the purpose of determining the speed of a first vehicle;
a first position locating system adapted to determine a location associated with the detection of the signal when the first sensor detects the signal; and
a transmitter for transmitting the determined location;
an alert unit having:
a receiver capable of receiving the determined location;
a second position locating system adapted to determine a location of a second vehicle; and
a position monitor adapted to compare the location of the second vehicle to the determined location and to notify an occupant of the second vehicle when the location of the second vehicle reaches a pre-specified proximity with the determined location.

73. A speed-detection alert system for installation in a vehicle, comprising:
a sensor capable of detecting a signal transmitted for the purpose of determining the speed of the vehicle;
a position locating system adapted to determine a current location; and
a location recording system for storing a plurality of locations associated with the detection of the signal when the sensor detects the signal;
a position monitor adapted to compare the current location to at least one of the stored plurality of determined locations and to activate a suppression signal while the current location is within a pre-specified proximity with at least one of the plurality of locations;
an alarm generator adapted to notify an occupant of the vehicle when the sensor detects a signal transmitted for the purpose of determining the speed of the vehicle if the suppression signal is not active.

74. The speed-detection alert system claimed in claim 73, wherein:
the position locating system is additionally adapted to determine the current direction of travel of the vehicle; and
the location recording system additionally stores the direction of travel associated with the vehicle when the sensor detects the signal.; and wherein

75. The speed-detection alert system claimed in claim 74, wherein the position monitor additionally compares the current direction of travel to the stored direction of travel, and is adapted not to activate a suppression signal unless the current direction of travel is within a pre-specified proximity with the stored direction of travel.
